(19) United States
(12) Patent Application Publication
(10) Pub. No.: US 2006/0143625 A1
(43) Pub. Date: Jun. 29, 2006

(54) Optical disc device and tray lock mechanism thereof

(75) Inventor: Chiu Chong Chuo, Hsinchu (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/073,561

(22) Filed: Mar. 8, 2005

(30) Foreign Application Priority Data
Dec. 24, 2004 (TW) 093140501

(51) Int. Cl. G11B 17/03; G11B 17/04; G11B 33/02

(52) U.S. Cl. 720/614

(57) ABSTRACT

The present invention relates to a multi-tray optical disc device and tray lock mechanism thereof. The tray lock mechanism includes a magazine which accommodates trays each having an indentation; a sliding cover provided with trenches; and an elastic sheet provided between the magazine and the sliding cover, the elastic sheet also includes plural spring strips each having a hook part and an extrusion part. During the sliding of the sliding cover, it can select to unlock one or all disc trays or lock all disc trays. According to the tray lock mechanism of the present invention, it is possible to prevent trays from falling suddenly out from the magazine due to gravity and shaking when user draws the cartridge out from the disc device.

This Non-provisional application claims priority under 35 U.S.C. §119(a) on Patent Application No(s). 093140501 filed in Taiwan, Republic of China on Dec. 24, 2004, the entire contents of which are thereby incorporated by reference.

### FIELD OF THE INVENTION

The present invention relates to an optical disc device, particular to an optical disc device with a tray lock mechanism.

### BACKGROUND OF THE INVENTION

Optical disc devices based on their disc carrying manners could be classified into a cover-lifting type, a slot-in type, a single-disc type, and a multi-disc type optical disc device. Among them, the multi-disc type optical disc device includes a multi-disc magazine for carrying discs and an ejection mechanism provided in the device for pulling a selected tray from the magazine according to user's instruction when the device is playing. Such a multi-disc magazine is mainly consisting of a magazine housing and plurality of disc trays. When a user wants to put discs in the magazine or change them with another one, the user should draw the magazine from the device, pull the disc trays out from the magazine, and then put discs on the disc tray or change the disc in the tray with another one.

However, in practice, when the magazine is drawn from the optical disc device, each disc tray is possible to fall out from the magazine by accident attributed to external shaking force and gravity. Thus the disc or the disc tray is easily damaged if the disc tray falls out from the magazine.

In the current optical disc device, a tray lock mechanism is provided inside the optical disc device. Such a tray loch mechanism is no function to lock the tray in the magazine or an additional tray lock mechanism is required if the magazine has been drawn out from the optical disc device. Even so, the function of current tray lock mechanism is to lock or unlock all trays at the same time and can not select to unlock one of them.

To solve the above problem, the present inventor has conducted an investigation on the magazine and its mechanism in the optical disc device and thus completed this invention.

### SUMMARY OF THE INVENTION

One object of the present invention is to provide a tray lock mechanism used in a multi-disc type optical disc device, which can prevent the disc tray from falling out from the magazine attributed to external shaking force and gravity when the magazine is drawn out from the optical disc device.

Accordingly, the present invention provides a tray lock mechanism used in a multi-disc type optical disc device. The optical disc device includes a housing and a reading apparatus which is movably provided in the housing. The tray lock mechanism comprises a magazine, plural disc trays, an elastic sheet, and a sliding cover. A guiding track is provided on one outer surface of the magazine; the disc trays are accommodated in the magazine and each disc tray has an indentation. The elastic sheet is fixed on the magazine and includes plural spring strips each having a hook part and an extrusion part. The sliding cover is movably fixed on the track and is slidable along the track. Also the inner surface of the sliding cover is provided with plural trenches. The indentation provided on the disc tray is used for being hooked by the hook part of the spring strip and the trenches are used for accommodating the extrusion part of the spring strip. When the sliding cover slides to a specific position, one or more of the extrusion parts is (are) accommodated in the trench(es) to allow the indentation of the disc tray releasing from the hook part so that the corresponding disc tray(s) is(are) unlocked.

Another object of the present invention is to provide a multi-disc type optical disc device, which includes a housing, a reading apparatus, and a tray lock mechanism. The reading apparatus is movably provided in the housing. The tray lock mechanism comprises a magazine, plural disc trays, an elastic sheet, and a sliding cover. A guiding track is provided on one outer surface of the magazine; the disc trays are accommodated in the magazine and each disc tray has an indentation. The elastic sheet is fixed on the magazine and includes plural spring strips each having a hook part and an extrusion part. The sliding cover is movably fixed on the track and is slidable along the track. Also the inner surface of the sliding cover is provided with plural trenches. The indentation provided on the disc tray is used for being hooked by the hook part of the spring strip and the trenches are used for accommodating the extrusion part of the spring strip. When the sliding cover slides to a specific position, one or more of the extrusion parts is (are) accommodated in the trench(es) to allow the indentation of the disc tray disengaging from the hook part so that the corresponding disc tray(s) is(are) unlocked.

In order to allow a user to unlock a certain disc tray or all disc trays after drawing the magazine from the optical disc device, an identification showing the disc tray number to be unlocked corresponding to the position of the sliding cover is provided on the magazine. Therefore, if a user is intended to unlock one of the disc trays, he only needs to slide the sliding cover to a position that the identification shows the selected disc tray number to unlock the appointed disc tray and pull the disc tray out from the magazine for taking out or change a disc.

### BRIEF DESCRIPTION OF DRAWINGS

The present invention is illustrated more detail by reference to the accompanying drawings, wherein:

FIG. 1 is a perspective view showing one embodiment of the tray lock mechanism for multi-tray type optical disc device according to the present invention;

FIG. 2 is a perspective drawing of the elastic sheet shown in FIG. 1;

FIG. 3a is a perspective drawing of inner side of the sliding cover shown in FIG. 1;

FIG. 3b is a perspective drawing of the outer side of the sliding cover shown in FIG. 1;

FIG. 4a is a top view drawing of the disc tray shown in FIG. 1;

FIG. 4b is a perspective drawing of the disc tray shown in FIG. 1;

FIGS. 5a-5c are top viewing perspective drawings showing that the magazine is carrying into the optical disc device in sequence;

FIG. 6 is a perspective drawing showing that the magazine has already been accommodated in the housing; and

FIGS. 7a-7b are sectional perspective drawings showing that the disc tray is locked and unlocked by the spring strip, respectively.

### DETAILED DESCRIPTION OF THE INVENTION

The present invention is illustrated in more detail by reference the following preferred embodiments which are only used for illustration without limiting the scope of the present invention.

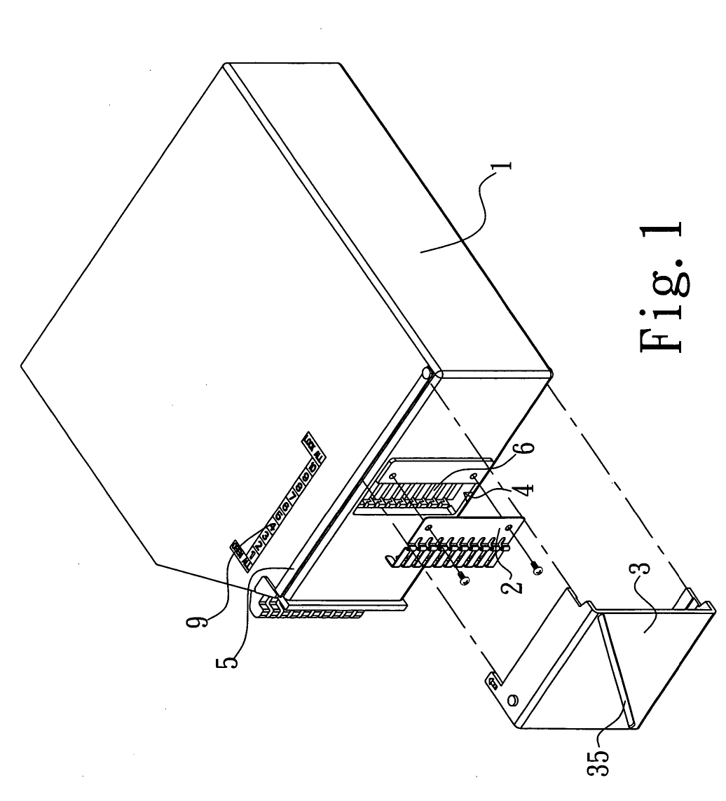

Please refer to FIG. 1. FIG. 1 is a perspective view showing one embodiment of the tray lock mechanism for multi-tray type optical disc device according to the present invention. The tray lock mechanism includes a magazine 1, an elastic sheet 2, and a “ [symbol] ” shape sliding cover 3. On the surface of the magazine 1 to be fixed with the elastic sheet 2 and the sliding cover 3, an open 4 is provided to allow the elastic sheet 2 inserting into the magazine 1 for hooking a disc tray 6 in the magazine 1. The elastic sheet 2 is positioned between the magazine 1 and the sliding cover 3. On one surface of the magazine 1, a guiding track 5 is provided. The sliding cover 3 is fixed on the track 5 and is slidable on one side of the magazine 1 along the track 5.

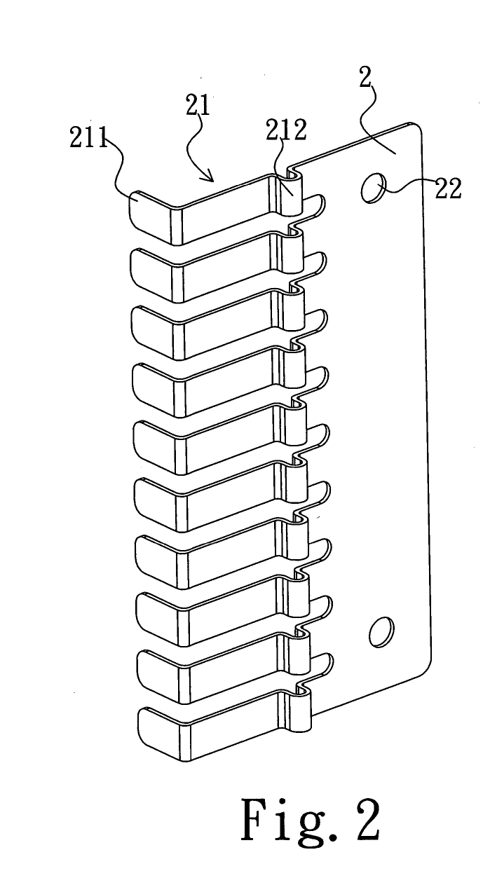

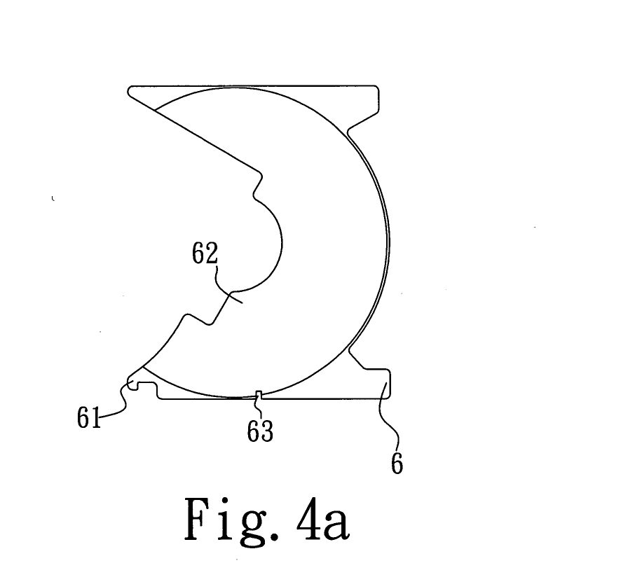

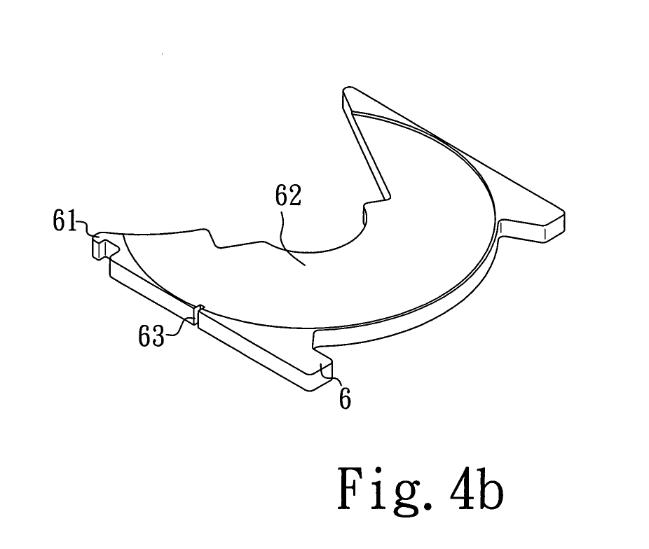

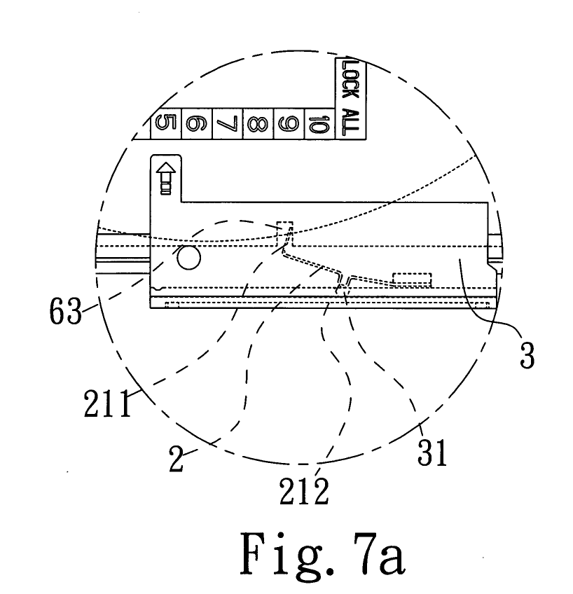

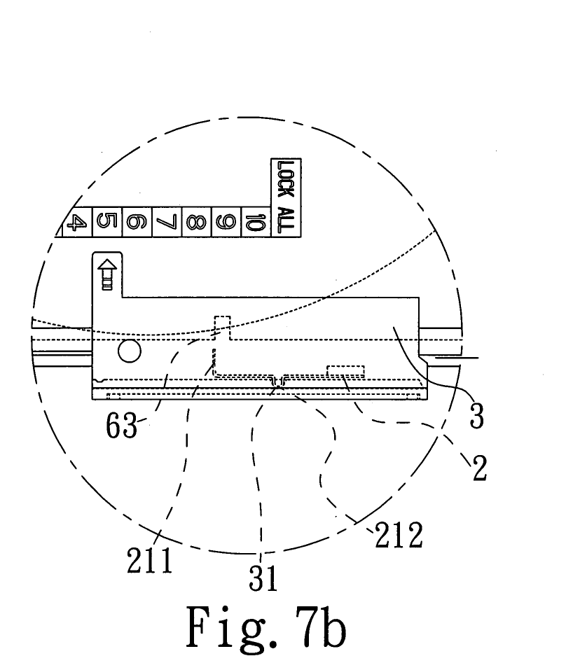

Next please refer to FIG. 2. FIG. 2 is a perspective drawing of the elastic sheet shown in FIG. 1. The elastic sheet 2 includes plural spring strips 21 each having a hook part 211 at its end and an extrusion part 212 at its middle position. When the extrusion part 212 is pressed, the hook part 211 moves to hook an indentation 63 provided on the disc tray 6 and thus lock the tray 6 (please refer to FIGS. 4b and 7a). When the pressing force on the extrusion part 212 is released, the elasticity of the spring strip 21 allows the hook part 211 back to its normal state, i.e. non-forced state so that the hook part 211 leaves the indentation 63 of the disc tray 6 to unlock the tray 6 (please refer to FIG. 7b). The elastic sheet 2 is further provided with a fixing part 22 for fixing the elastic sheet 2 on the magazine 1 in a position.

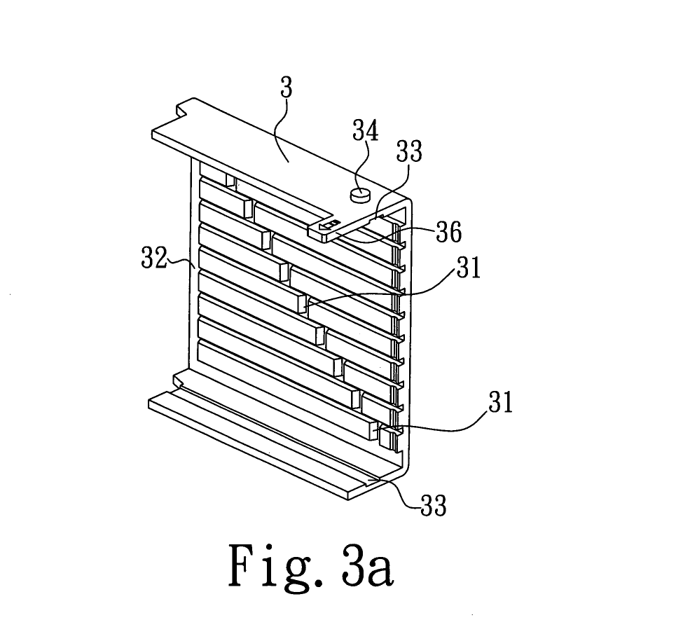

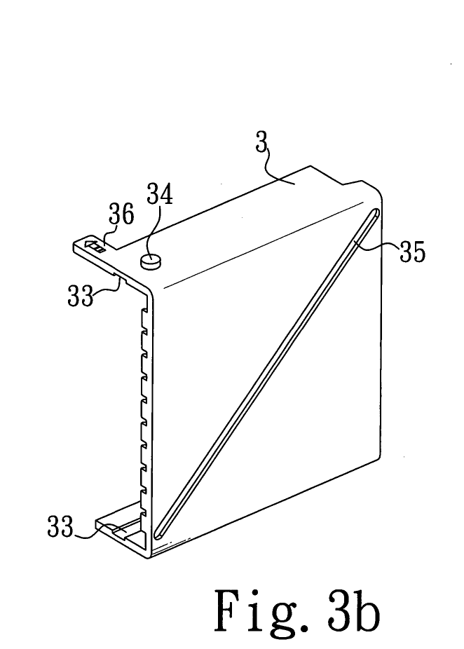

Next please refer to FIG. 3. FIG. 3a is a perspective drawing of inner side of the sliding cover shown in FIG. 1; FIG. 3b is a perspective drawing of the outer side the sliding cover shown in FIG. 1. As shown in FIG. 3a, plural trenches 31 arranging in a stair are provided on the inner surface of the sliding cover 3 to accommodate the extrusion part 212 of each spring strip 21 so that each tray is selectively locked/unlocked. The horizontal position of each trench 31 is corresponding to the horizontal position of each spring strip 21. Plural trenches 32 arranging in a vertical line are further provided on one side of inner surface of the sliding cover 3 to accommodate all extrusion part 212 of each spring strip 21 at the same time so that all trays are unlocked simultaneously. The horizontal position of each trench 32 is corresponding to the horizontal position of each spring strip 21. Also, when the sliding cover 3 is slid to a position that no trench 31 or 32 accommodates the extrusion part 212, i.e. all hook parts 211 are remained to hook the indentation 63 provided on the disc tray 6 and lock the tray 6, the tray lock mechanism of the present invention will lock all trays.

Moreover, at least one guiding trench 33 is provided on the inner surface of the flank side of the sliding cover 3 to engage with the guiding track 5 provided on the magazine 1 so that the sliding cover 3 will be slid on the magazine 1 in a predetermined direction alone the guiding track 5. A marker block 36 and a positioning block 34 are further provided on the flank side of the sliding cover 3. An identification label 9 showing the position of the sliding cover 3 corresponding to the number of tray is provided on the magazine 1 (please refer to FIG. 1) so that user can select the tray to be unlocked by viewing the number on the identification label 9 corresponding to the marker block 36. Also, a slope guiding trench 35 is further provided on the outer surface of the sliding cover 1. Functions of the positioning block 34 and the slope guiding trench 35 will be illustrated hereinafter.

Please refer to FIG. 4. FIG. 4a is a top view drawing of the disc tray shown in FIG. 1 and FIG. 4b is a perspective drawing of the disc tray shown in FIG. 1. The tray 6 includes a hook 61 to allow an ejection mechanism pulling, a disc supporting portion 62 for accommodating a disc, and an indentation 63 at one side of the tray corresponding to the position of the hook part 211 of the spring strip 21 for being hooked by the hook part 211 of the spring strip 21.

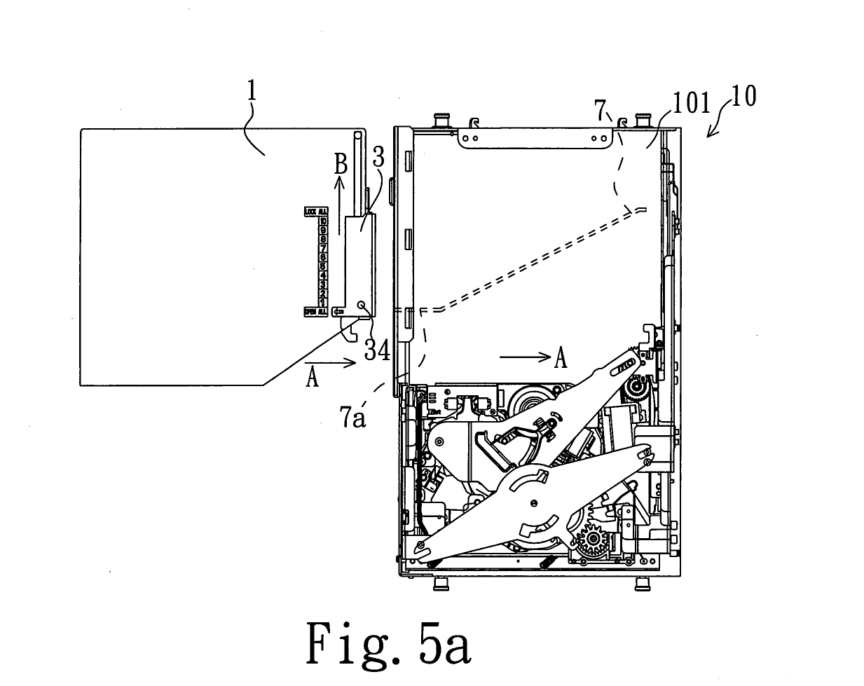

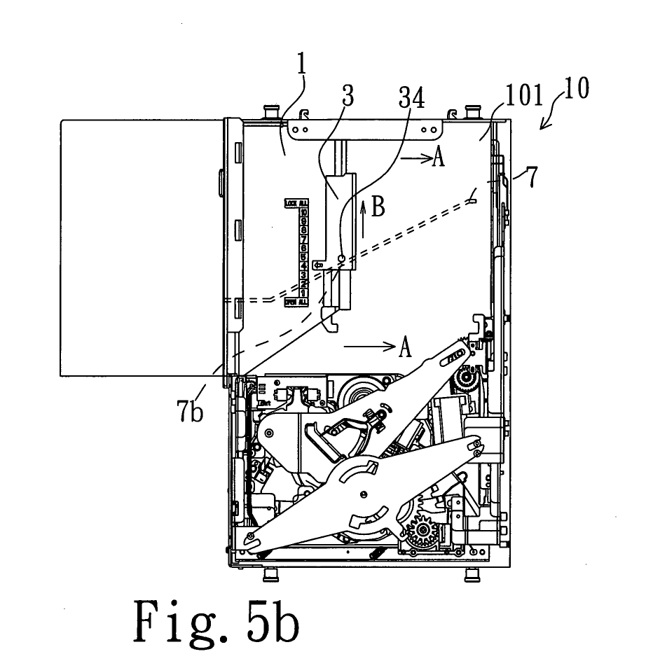

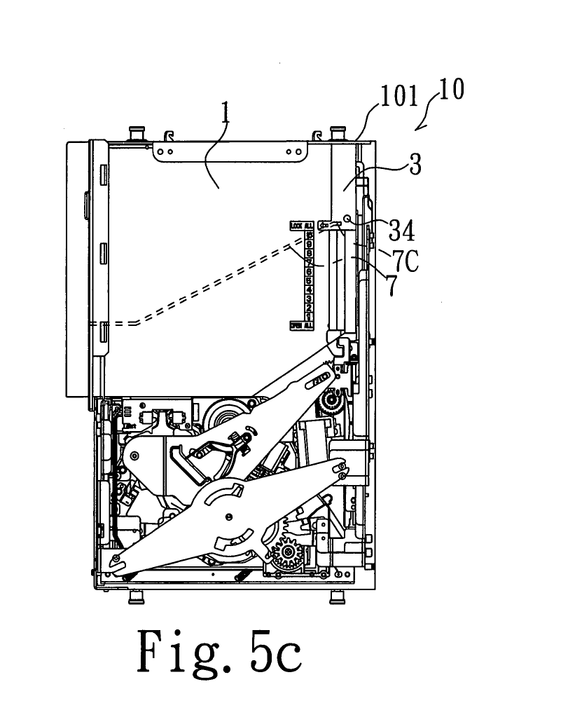

FIGS. 5a-5c are top viewing perspective drawings showing that the magazine is carrying into the optical disc device in sequence. The optical disc device 10 includes a housing 101 for accommodating the magazine 1. A slope guiding step 7 is provided on the inner surface of the housing 101. When the magazine 1 is carried into the housing 101 in a direction along the arrow A (as shown in FIG. 5a), the position block 34 is against the slope guiding step 7 to allow the sliding cover 3 being pushed, slid, and guided by the guiding track 5 on the magazine 1 in a direction along the arrow B (as shown in FIG. 5b). When the magazine 1 is completely carried into the housing 101, the sliding cover 3 is guided to a designated position as shown in FIG. 5c. The designated position is a position that all trays in the magazine 1 are locked.

As shown in FIG. 5a, when the magazine 1 is carried into the housing 101 in a direction along the arrow A, the positioning block 34 contacts with the slope guiding step 7 at a position 7a. Then as shown in FIG. 5b, with the magazine 1 carrying into the housing 101 further, the positioning block 34 allows the sliding cover 3 sliding to the position 7b along arrow B since the block 34 is stopped and guided by the slope guiding step 7. Finally as shown in FIG. 5c, when the magazine 1 is completely carried into the housing 101, the positioning block 34 allows the sliding cover 3 further sliding to the position 7c along arrow B. In this position, all trays in the magazine are locked by the tray lock mechanism.

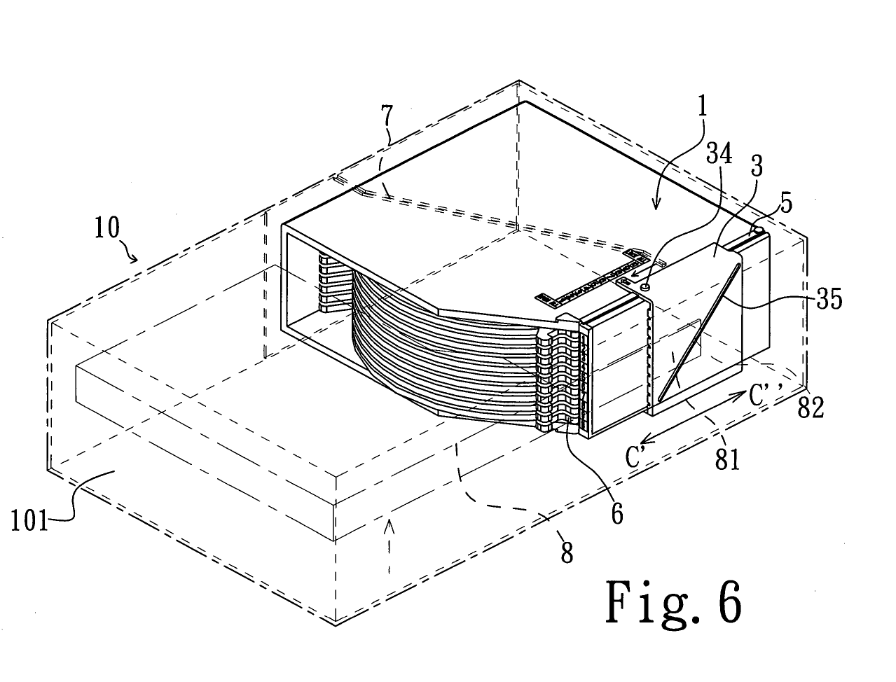

FIG. 6 is a perspective drawing showing that the magazine has already been accommodated in the housing. The optical disc device 10 further includes a reading apparatus 8 which is moveable vertically in the device 10 to select and eject the tray 6 out from the magazine 1 according to the user's instruction. Then a pick-up unit (not shown in the Figure) disposed on the reading apparatus 8 will read/write the selected disc. The reading apparatus 8 is further provided with a driving arm 81 extending to contact with the sliding cover 3. The driving arm 81 is further provided with a cylinder 82 at its end. When the magazine 1 is completely carried into the housing 101, the cylinder 82 will locate into the slope guiding trench 35. As shown in FIG. 6, the reading apparatus 8 moves up/down to select and eject the selected tray out from the magazine 1, the driving arm 81 and cylinder 82 also move with the movement of the reading apparatus 8 so that the cylinder 82 is moving in the slope guiding trench 35 to guide the sliding cover 3 moving forward/back in a direction along arrow C′-C″. The reading apparatus 8 includes an ejection mechanism for drawing the tray from the magazine and a pick-up unit for reading the data recorded on the disc. Due to the structure of the reading apparatus 8 is well known in this field, the detailed describe of the structure of the reading apparatus 8 is omitted.

Since the plural trenches 31 arranging in a stair are provided on the inner surface of the sliding cover 3 and each trench 31 is corresponding to each extrusion part 212, and since all extrusion parts 212 are arranged in a vertical line, only one extrusion part 212 could be accommodated in one trench 31 and thus only one disc tray 6 is unlocked when the sliding cover 31 is moving forward/back in the direction C′-C″. However, if the sliding cover 3 is moving forward to the end in a direction of C′, all extrusion parts 212 could be accommodated in trenches 32 arranging in a vertical line and thus all disc trays 6 are unlocked. Moreover, if the sliding cover 3 is moving back to the end in a direction of C″, all hook parts 211 remain to hook all indentations 63 and lock all trays 6.

In operation, initially, when the magazine 1 is completely accommodated in the housing 101, the sliding cover 3 is moved to the end in a direction of C″ by the guiding of the slope guiding step 7 and the reading apparatus 8 is at the bottom of the housing 101. If someone intends to select the disc in disc tray No. 5, the reading apparatus 8 will move up to a position corresponding to the tray No. 5, the driving arm 81 is accordingly moving up so that the cylinder 82 allows the sliding cover 3 sliding forward to a position corresponding to the tray No. 5. In this time, the extrusion part 212 of the spring strip 21 corresponding to the tray No. 5 would be accommodated in the corresponding trench 31 of the sliding cover 3 and the hook part 211 would release the corresponding indentation 63 to allow the tray No. 5 being unlocked. Thus the reading apparatus 8 would pull the tray No. 5 from the magazine 1 and let optical pick-up unit read/write the disc in tray No. 5.

When the optical disc device stops action, all trays are back to the magazine 1, the reading apparatus 8 is moving down to the bottom and the cylinder 82 is also moving down in the slope guiding trench 35 to guide the sliding cover 3 sliding back to the end of C″, i.e. a position that all trays are locked. According to the tray lock mechanism of the present invention, when the optical disc device stops action, all trays 6 in the magazine 1 are locked so that if the magazine 1 is drawn out from the device, the disc tray 6 would not fall out from the magazine 1 attributed to external shaking force and gravity.

Finally please refer to FIG. 7. FIGS. 7a-7b are sectional perspective drawings showing that the disc tray is locked and unlocked by the spring strip, respectively. If the sliding cover 3 is moving to a position corresponding to tray No. 5 to be unlocked, the extrusion part 212 of the spring strip 21 is accommodated in the trench 31 corresponding to tray No. 5 to unlock the tray. As shown in FIG. 7a, the trays other than tray No. 5 are locked since no corresponding extrusion part 212 of the spring strip 21 is accommodated in the trench 31. As shown in FIG. 7b, only tray No. 5 is unlocked since the extrusion part 212 of the spring strip 21 corresponding to tray No. 5 is accommodated in the trench 31 so that the hook part 211 releases the indentation 63 provided on the disc tray No. 5.

According to the tray lock mechanism for multi-tray type optical disc device of the present invention, by using the trenches arranging in a stair which can accommodate different extrusion part when the sliding cover moves to different position, thereby the tray lock mechanism can select to unlock a selected disc tray in the magazine. Also, by using the trenches arranging in a vertical line which can accommodate all extrusion parts at the same time, thereby the tray lock mechanism can select to unlock all disc tray in the magazine. Therefore according to the tray lock mechanism for multi-tray type optical disc device of the present invention, it can select to unlock one or all disc trays or lock all disc trays.

According to the tray lock mechanism for multi-tray type optical disc device of the present invention, when a magazine is carried into the optical disc device, a positioning block allows the sliding cover sliding to the position that all disc trays are locked due to the slope guiding track regardless the position of the sliding cover when magazine carrying into the device.

According to the tray lock mechanism for multi-tray type optical disc device of the present invention, the reading apparatus will move up/down to select an appointed tray, which in turn cause the sliding cover to slide forward/back to a position corresponding to the appointed tray and allow the tray to be unlocked.

When the optical disc device stops action, all trays are back to the magazine, the reading apparatus is moving down to the bottom and the cylinder is also moving down in the slope guiding trench to guide the sliding cover sliding back to the position that all trays are locked so that all disc trays would not fall out from the magazine attributed to external shaking force and gravity.

According to the tray lock mechanism for multi-tray type optical disc device of the present invention, when the magazine is draw out from the optical disc device, a user can slide the sliding cover to an appropriate position to unlock one or all disc trays or to lock all disc trays. Furthermore, when the optical disc device is in action, all disc trays are remained as a lock state in addition to the disc tray to be reading, therefore the disc trays would not fall out from the magazine attributed to external shaking force and gravity when the magazine is draw out from the optical disc device and the lock function of the tray lock mechanism of the present invention is also workable when the magazine is put into the optical disc device without other lock mechanism. Accordingly, the cost is saved and the damages of the tray and the disc are prevented.

While the present invention has been particularly shown and described with reference to exemplary embodiments thereof, it will be understood by those of ordinary skill in the art that various changes and modifications may be made therein without departing from the spirit and scope of the present invention as defined by the following claims.

What is claimed is:

1. A tray lock mechanism used in a multi-disc type optical disc device, in which the optical disc device includes a housing and a reading apparatus which is movably provided in the housing, the tray lock mechanism comprises:
a magazine, on its outer surface a guiding track is provided;
plural disc trays, which are accommodated in the magazine and each disc tray has an indentation;
an elastic sheet, which is fixed on the magazine and includes plural spring strips each having a hook part and an extrusion part; and
a sliding cover, which is movably fixed on the guiding track and is slidable along the guiding track, on its inner surface plural trenches are provided;
wherein the indentation provided on the disc tray is used for engaging with the hook part on the spring strip and the trenches are used for accommodating the extrusion part on the spring strip;
thereby when the sliding cover slides to a specific position, one or more of the extrusion parts is (are) accommodated in the trench(es) to allow the indentation of the disc tray disengaging from the hook part so that the corresponding disc tray(s) is(are) unlocked.

2. The tray lock mechanism according to claim 1, wherein the trenches provided on the inner surface of the sliding cover include the trenches both arranging in a stair and in a vertical line.

3. The tray lock mechanism according to claim 1, wherein the horizontal position of each trench is horizontally corresponding to that of each spring strip.

4. The tray lock mechanism according to claim 1, wherein a positioning block is further provided on the flank side of the sliding cover and a slope guiding step is provided on the inner surface of the housing, thereby when the magazine is carried into the housing, the position block is against the slope guiding step to allow the sliding cover being pushed, slid, and guided by the guiding track on the magazine.

5. The tray lock mechanism according to claim 1, wherein a slope guiding trench is further provided on the outer surface of the sliding cover and the reading apparatus is further provided with a driving arm extending to contact with the sliding cover, the driving arm includes a cylinder at its end to locate into the slope guiding trench when the magazine is carried into the device completely.

6. The tray lock mechanism according to claim 1, wherein an identification label showing the position of the sliding cover corresponding to the number of tray is provided on the magazine.

7. A multi-disc type optical disc device, which comprises:
a housing;
a reading apparatus which is movably provided in the housing; and
a tray lock mechanism comprising:
a magazine, on its outer surface a guiding track is provided;
plural disc trays, which are accommodated in the magazine and each disc tray has an indentation;
an elastic sheet, which is fixed on the magazine and includes plural spring strips each having a hook part and an extrusion part; and
a sliding cover, which is movably fixed on the guiding track and is slidable along the guiding track, on its inner surface plural trenches are provided;
wherein the indentation provided on the disc tray is used for engaging with the hook part on the spring strip and the trenches are used for accommodating the extrusion part on the spring strip;
thereby when the sliding cover slides to a specific position, one or more of the extrusion parts is (are) accommodated in the trench(es) to allow the indentation of the disc tray disengaging from the hook part so that the corresponding disc tray(s) is(are) unlocked.

8. The optical disc device according to claim 7, wherein the trenches provided on the inner surface of the sliding cover include the trenches both arranging in a stair and in a vertical line.

9. The tray lock mechanism according to claim 7, wherein the horizontal position of each trench is horizontally corresponding to that of each spring strip.

10. The optical disc device according to claim 7, wherein a positioning block is further provided on the flank side of the sliding cover and a slope guiding step is provided on the inner surface of the housing, thereby when the magazine is carried into the housing, the position block is against the slope guiding track to allow the sliding cover being pushed, slid, and guided by the guiding track on the magazine.

11. The optical disc device according to claim 7, wherein a slope guiding trench is further provided on the outer surface of the sliding cover and the reading apparatus is further provided with a driving arm extending to contact with the sliding cover, the driving arm includes a cylinder at its end to locate into the slope guiding trench when the magazine is carried into the device completely.

12. The optical disc device according to claim 7, wherein an identification label showing the position of the sliding cover corresponding to the number of tray is provided on the magazine.
